(19) United States
(12) Patent Application Publication
(10) Pub. No.: US 2024/0241362 A1
(43) Pub. Date: Jul. 18, 2024

(54) FOLDED LIGHT PATH OPTIC HOUSING WITH INTEGRALLY FORMED CHANNEL SECTIONS

(71) Applicant: LEUPOLD & STEVENS, INC., Beaverton, OR (US)

(72) Inventors: Xuyen HUYNH, Beaverton, OR (US); Martin KOORNNEEF, Beaverton, OR (US)

(21) Appl. No.: 18/412,349

(22) Filed: Jan. 12, 2024

Related U.S. Application Data
(60) Provisional application No. 63/439,086, filed on Jan. 14, 2023.

(51) Int. Cl. G02B 23/16; G02B 17/02; G02B 23/02; F41G 11/00

(52) U.S. Cl. CPC G02B 23/16; G02B 17/023; G02B 23/02; F41G 11/003

(57) ABSTRACT

Various embodiments described herein may include a folded optic, comprising: a housing having ends and a length, wherein the housing includes: an objective channel section defining an objective channel; and an additional channel section integrally formed with the objective channel section, the additional channel section defining an additional channel that is non-coaxial with the objective channel; an objective lens assembly mounted to the objective channel section; and an additional lens assembly mounted to the additional channel section. Other embodiments may be disclosed and/or claimed.

### PRIORITY

This application claims priority to U.S. Provisional Application No. 63/439,086, filed on Jan. 14, 2023, which is incorporated by reference herein.

### TECHNICAL FIELD

The field of the present disclosure relates generally to optical devices, and more particularly to folded optics (e.g., optic devices having folded light paths).

### BACKGROUND

Folded optics have an optical system that bends a beam to provide an optical path that may be longer than the optical system. This may provide a desired objective focal length in a small form factor.

### BRIEF DRAWINGS DESCRIPTION

The accompanying drawings, wherein like reference numerals represent like elements, are incorporated in and constitute a part of this specification and, together with the description, explain the advantages and principles of the presently disclosed technology.

FIG. 1A illustrates an isometric view of a folded optic housing, according to various embodiments.

FIG. 1B illustrates an end view of the folded optic housing of FIG. 1A.

FIG. 1C illustrates a section view of the folded optic housing taken along section line B-B of FIG. 1B.

FIG. 2A illustrates an isometric view of a folded optic with a housing having integrally formed channel sections, according to various embodiments.

FIG. 2B is an exploded view of the folded optic of FIG. 2A.

FIG. 2C is an end view of the folded optic of FIG. 2A.

FIG. 2D is a cross section view of the folded optic of FIG. 2A.

FIG. 3A is an end view of a folded optic housing in which a distance between center axes of openings of the folded optic housing is greater than one half of a sum of widths of the openings of the folded optic housing.

FIG. 3B is an end view of a folded optic housing in which a distance between center axes of openings of the folded optic housing is less than one half of a sum of widths of the openings of the folded optic housing.

FIG. 4A is a cross section view of the folded optic housing of FIG. 3A taken along section line B′ of FIG. 3A.

FIG. 4B is a cross section view of the folded optic housing of FIG. 3B taken along section line A′ of FIG. 3B.

### DETAILED DESCRIPTION

With reference to the drawings, this section describes particular embodiments and their detailed construction and operation. Throughout the specification, reference to “one embodiment,” “an embodiment,” or “some embodiments” means that a particular described feature, structure, or characteristic may be included in at least one embodiment. Thus appearances of the phrases “in one embodiment,” “in an embodiment,” or “in some embodiments” in various places throughout this specification are not necessarily all referring to the same embodiment. Furthermore, the described features, structures, and characteristics may be combined in any suitable manner in one or more embodiments. In view of the disclosure herein, those skilled in the art will recognize that the various embodiments can be practiced without one or more of the specific details or with other methods, components, materials, or the like. In some instances, well-known structures, materials, or operations are not shown or not described in detail to avoid obscuring aspects of the embodiments.

Spotting scope housings may be made from metal or plastic. However, the choice of material may impact the method of manufacture of the housing. For example, in the case of metal housings, the use of aluminum may allow a housing to be formed by machining from billet, or a combination of casting and machining.

Magnesium is significantly lighter than aluminum—a magnesium housing for the spotting scope may weight eight ounces less than the same housing in aluminum. Magnesium can be cast with thinner walls, lower porosity and better mechanical properties than typical aluminum cast alloys. As such, magnesium housings are desirable for various folded optic applications.

For a number of reasons, with known magnesium spotting scopes, the housing may be formed by die-casting two separate pieces. These two pieces may then be joined together using a post-molding joining process (such as an adhesion process or other joining process to join two molded components).

These known magnesium spotting scopes may also have eyepiece and erector assemblies, which may be attached to the magnesium housing. Known two-piece magnesium housings with having eyepiece/erector assemblies may allow some movement of one or more of the assemblies in relation to the housing. When the spotting scope has an internal reticle, his movement may result in misalignment of externally mounted devices such as rangefinders in relation to the internal reticle, which may prevent the reticle from functioning as an accurate aiming device for the laser rangefinder.

Some other disadvantages of various known magnesium spotting scopes may include:
A shape of some known housings may allow ambient light to pass straight from the objective into the front element of the eyepiece/erector assembly;
The magnesium housing may be prone to galvanic corrosion if not protected by a covering finish and in contact with a dissimilar metal (e.g., if the magnesium of the housing is in contact with a fastener of a dissimilar metal); and/or
The housing may leak because of insufficient adhesive bond and/or gasket seal.

Various embodiments described herein may utilize new housing architecture/design optimized for single-piece molding. This new housing architecture/design allows a spotting scope housing to be formed by molding a single piece (e.g., die-casting a single magnesium piece or injection molding a single plastic piece). This may eliminate the post-molding joining processes, such as the adhesion process used in known two-piece constructions. A folded optic having a housing manufactured from a single molded piece may be lightweight, and may avoid one or more of the disadvantages of plural-piece housings described herein, or otherwise associated with known spotting scopes with plural-molded-piece housings joined using post-molding process(es).

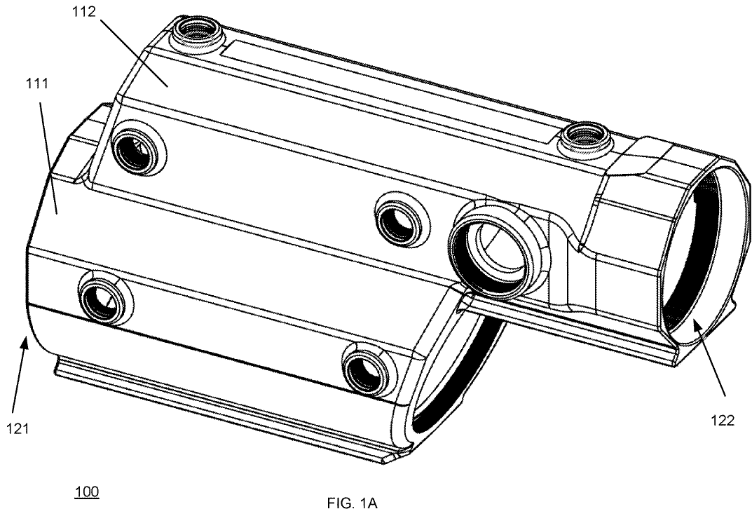

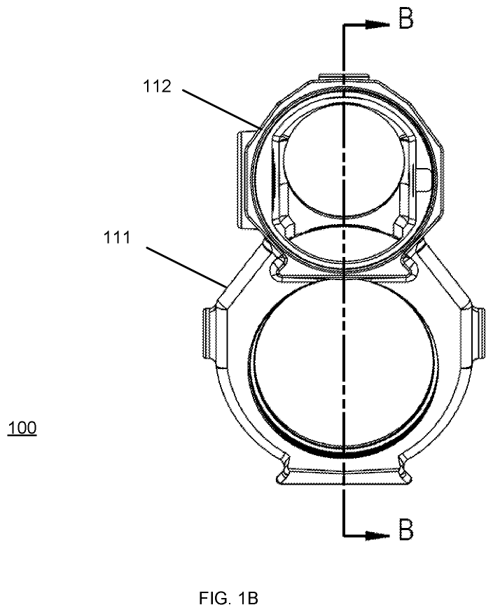

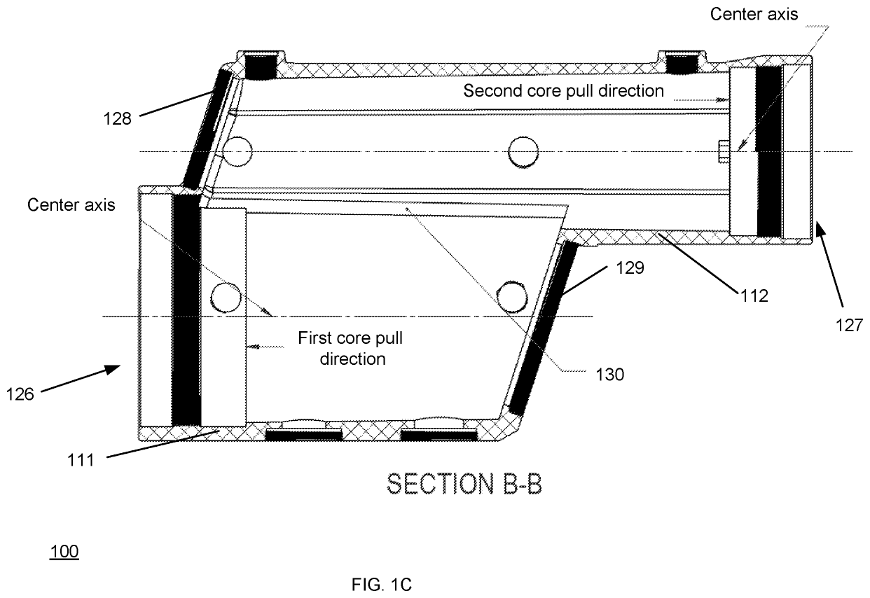

FIG. 1A illustrates an isometric view of a folded optic housing 100, according to various embodiments. FIG. 1B illustrates an end view of the folded optic housing 100 of FIG. 1A. FIG. 1C illustrates a section view of the folded optic housing 100 taken along section line B-B of FIG. 1B.

The housing 100 has non-coaxial channels provided by an objective channel section 111 and an additional channel section 112. The additional channel section 112 is integrally formed with the objective channel section 111. The housing 100 may be a single monolithic part, such as a monolithic magnesium manufacture or a monolithic plastic manufacture.

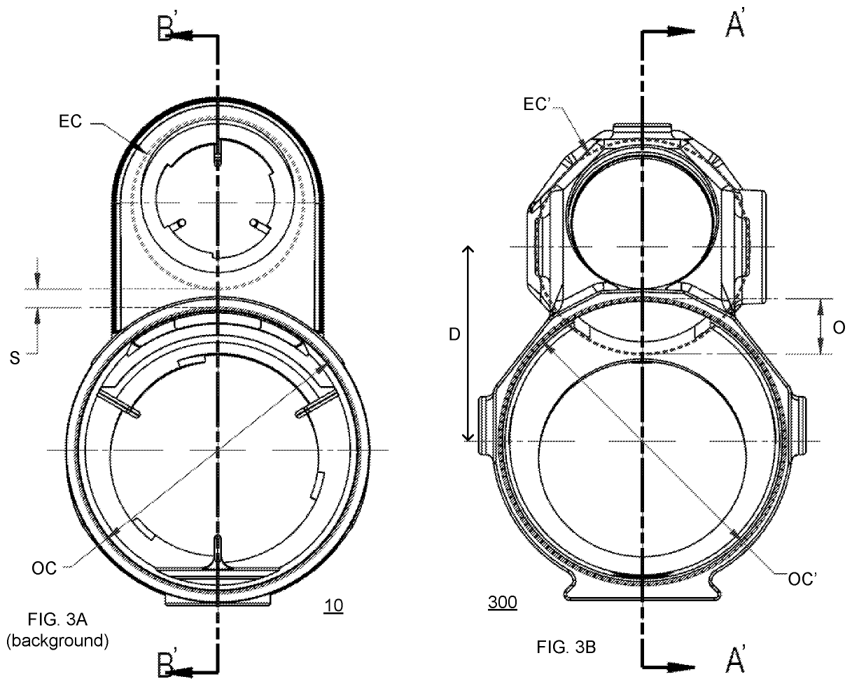

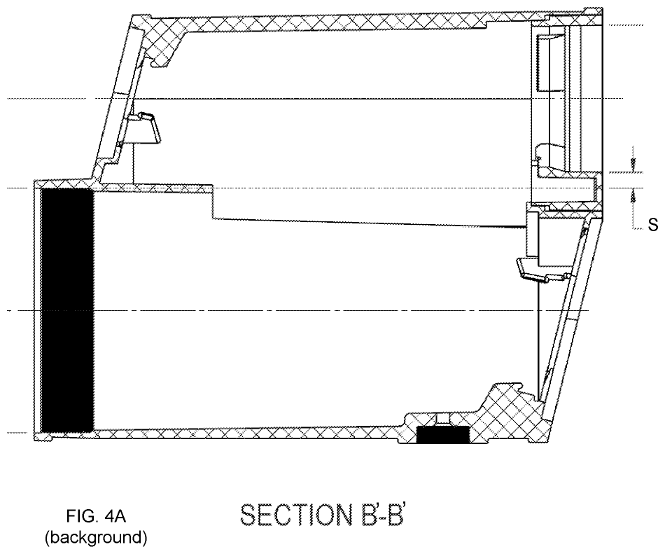

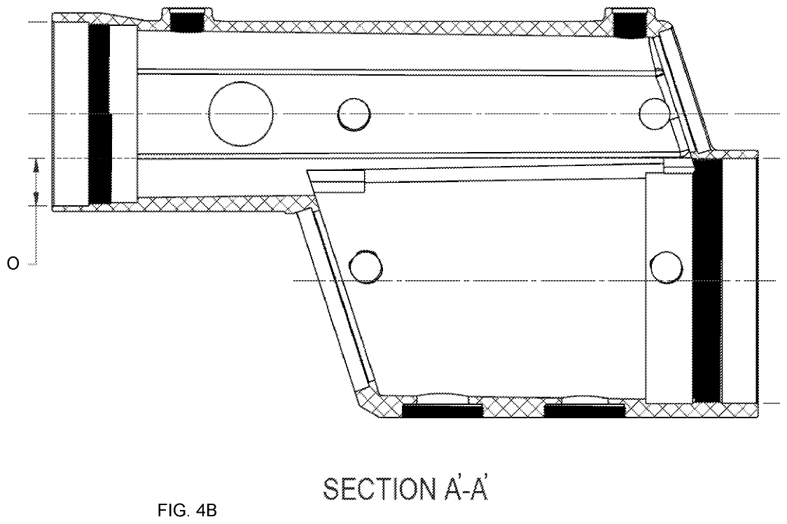

The housing 100 uses a different housing design/architecture than some known spotting scopes. This can best be seen by comparing FIGS. 3A and 4A (which illustrate end and cross sectional views, respectively, of a known spotting scope 10) and FIGS. 3B and 4B (which illustrate end and cross sectional views, respectively, of a spotting scope 300 similar in any respect to spotting scope 100 of FIG. 1A). FIG. 4B also illustrates the use of channel sidewalls having tapering thickness (the sidewalls thin approaching the core openings), which may support geometries optimized for single-piece molding processes.

In the known spotting scope architecture/design, the non-coaxial channels are spaced apart a distance S (FIGS. 3A and 4A), which may be greater than one sixth of an inch. In contrast, the spotting scope 300 (FIGS. 3B and 4B) may have channel center axes that are much closer together. In the illustrated example, the distance D is 1.851 inches, but other values may be used in other examples.

The openings at the opposite ends of the spotting scope 300 are not vertically spaced apart from each other like in the known spotting scope 10. Additionally, the spotting scope 300 includes an overlap O, which is not present on the spotting scope 10. In this example, the overlap O is 0.527 inches, but greater or less overlap amounts may be used.

In this example, a width of the objective channel OC′ of spotting scope 300 at the corresponding opening may be the same size as the width of the objective channel OC of spotting scope 10. In this example, a width of the eyepiece channel EC′ of the spotting scope 300 at the corresponding opening may be larger than a width of the objective channel EC of spotting scope 10 (e.g., 2.040 inches vs. 1.632 inches).

Referring again to FIG. 1A, the housing 100 includes an opening 121 with a width similar to a width of objective channel OC′ (FIG. 3A) and an opening 122 with a width similar to a width of eyepiece channel EC′ (FIG. 3B). The architecture/design of spotting scope 300 may be characterized by either or both of the following characteristics:
A distance D between channel axes that is not greater than one half of a sum of the widths of EC′ and OC′ (e.g., not greater than a sum of the radii of EC′ and OC′); and/or
The presence of the overlap O of the openings.

Molding components/tools (i.e. devices used to fabricate a molded part) may include a mold and cores (such as die cores in the case of die casting). Cores are components that are typically used during molding to produce holes or openings. Referring to FIG. 1C, cores may be used to form the non-coaxial channels. For brevity, the cores are not shown in this illustration, but arrows are provided indicating the opposite core pull directions. A first core is pulled in a first direction (forming a first core opening 126), and a second core is pulled in a second opposite direction (forming second core opening 127).

One challenge of molding a monolithic housing for a folded optic may be to get the internal die cores close enough together to have a very thick web to machine out (as a thick web may form substantial porosity). The cores also need to be able to slide out of the housing unobstructed, without leaving thick areas of material (or there may be porosity). The cores may need to form a round hole in the front for a round objective lens, and a round hole in the upper channel on the back to support a round erector-eyepiece lens assembly. This may drive a need for a reduced distance between center axes of these channels.

However, reducing this distance (as compared to some known plural-piece housings) may also establish a distance that allows light from outside the field of view to enter the objective and directly enter the first element of the eyepiece-erector assembly. Unmanaged, this may result in veiling glare that may interfere with the image and, in certain lighting conditions may render it unusable. As a counter measure, asymmetric baffles may be used to block light traveling through the folded optic outside the image forming light path. In addition, some of the constructive, image-producing light may also be intentionally clipped as a tradeoff to assure good glare performance.

Referring again to FIG. 1C, due to the reduced distance between the center axes (as compared to some known plural-piece housings), the molding tooling (including the cores) may leave only a thin wall 130 between the channels. This thin wall 130 may be in the form of a thin web of material, which may be easily machined out without creating defects in the housing 100.

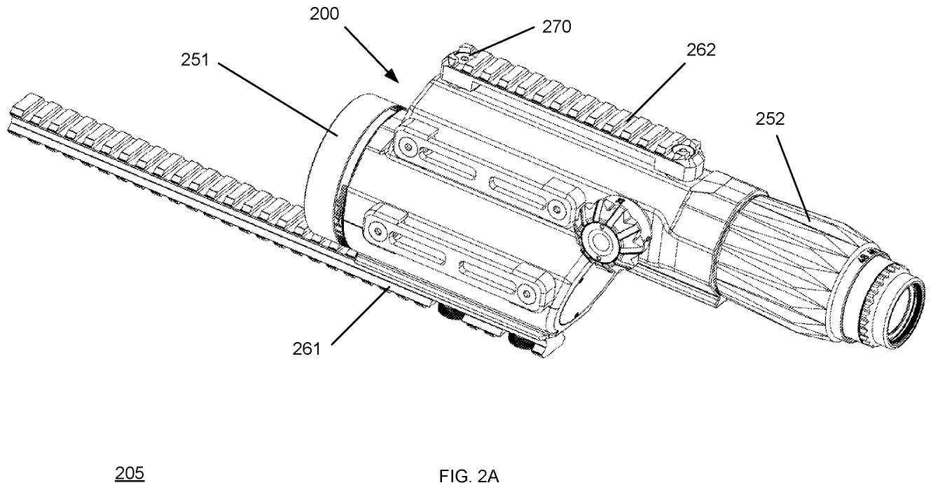

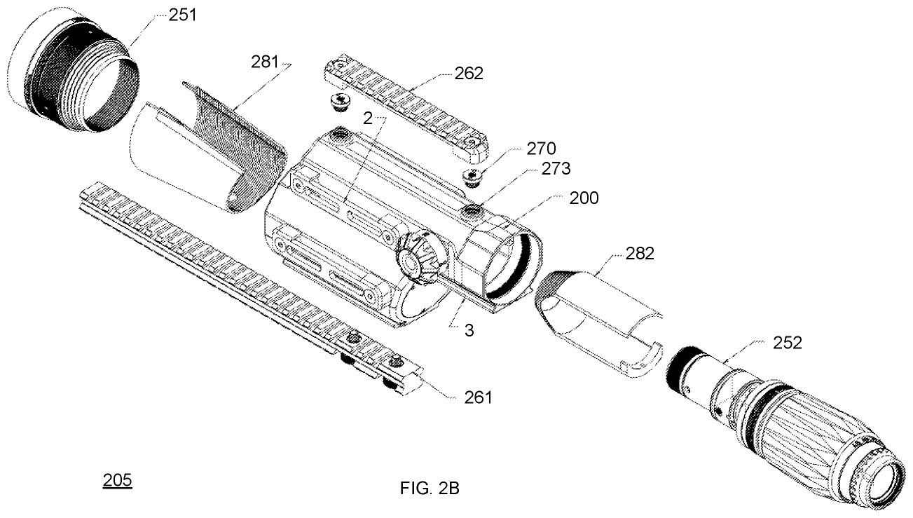

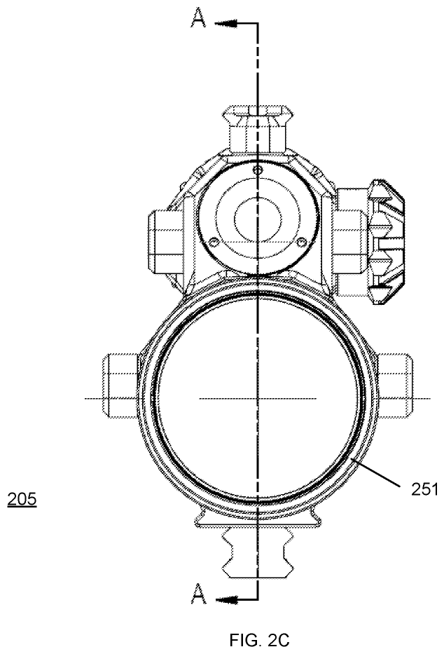

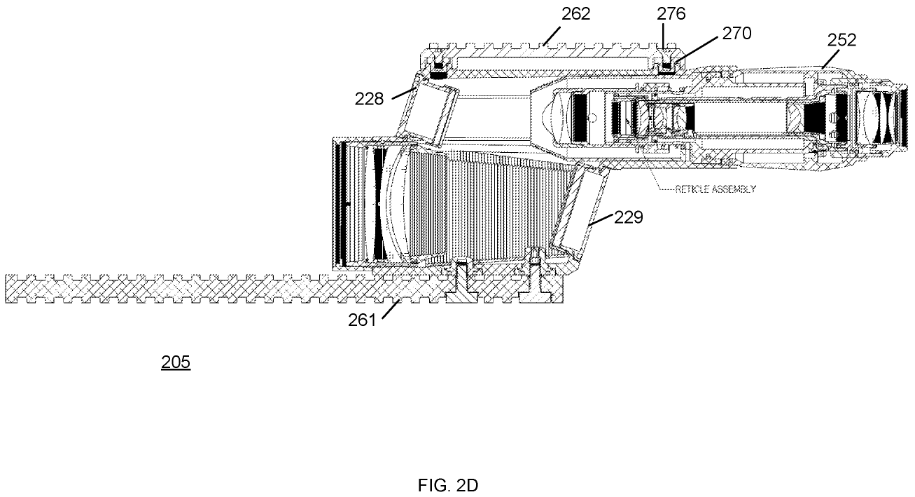

FIG. 2A illustrates an isometric view of a folded optic 205 with integrally formed channel sections, according to various embodiments. FIG. 2B is an exploded view of the folded optic 205 of FIG. 2A. FIG. 2C is an end view of the folded optic 205 of FIG. 2A. FIG. 2D is a cross section view of the folded optic 205 of FIG. 2A.

Referring to FIG. 2B, the housing 200 may be similar in any respect to housing 100 (FIGS. 1A-C). An objective lens assembly 251 and an eyepiece/erector assembly 252 may be located in core openings of the housing 200.

As described previously herein, the reduced distance between the center axes may affect optical characteristics of a folded optic using the monolithic molded housing. Asymmetric baffles 281 and 282 may be located in each core opening to block light traveling through the folded optic outside the image forming light path.

The folded optic 205 may include various external interfaces for mounting the folded optic and/or for mounting devices thereto (such as accessory rails). Any housing described herein may include attachment point(s) for accessory rails, which may include through holes 273 and adapters 270 (e.g., ring-shaped adapters having a threaded exterior to install to a housing and a threaded interior to receive a threaded fastener length). Particularly when the housing is formed from magnesium having a protective coating, through holes 273 may be employed to allow clamping of a flange and nut that adapts the hole to a standard thread without breaking through the protective coating of the magnesium. This may also allow the holes to be cast-in which may form a completely nonporous skin over the hole's surface. A sealing device (e.g., an O-ring) and/or liquid sealant may be employed to contain the internal dry gas. This allows the thread that users access for accessory attachment to be made of a harder material than magnesium (e.g., fasteners to thread into the adapters 270 may be made from the material harder than magnesium). In addition, it allows inexpensive repair should a thread ever be damaged.

Referring briefly to FIG. 2D, the adapter 270 may provide a threaded hole in which the fastener 276 may be installed, to attach the attachment device 262 (e.g., a rail such as a Picatinny rail accessory, or any uni-directional or bi-directional mounting device) to the housing 200. The fastener 276 may be made from a material different (e.g., harder) than magnesium. Referring again to FIG. 2B, a longer attachment device 261 may be attached in a similar way to an opposite side of the folding optic 205.

In this example, center axes of the interior and exterior holes of the adapters 270 are co-axial. The adapters 270 may be formed from a material that is harder than a material of the housing 200, in some examples.

In this example, the housing 200 also includes integrally formed attachment structures. In particular, the housing 200 defines an undercut attachment structure 3 (e.g., a male undercut attachment structure), which is a male dovetail in this example (e.g., a rail (e.g., an ARCA rail) or some other mounting system that may allow the folding optic to be mounted to a tripod or other platform). The housing 200 also defines a mounting system 2, such as an M-LOK® rail accessory.

Any of the molded housing features described herein can be used in any folded optic having non-coaxial channel sections that are integrally formed (e.g., a monolithic folded optic housing). The housing may be made from any single material, such as magnesium, plastic, or some other material, as desired.

In some embodiments, one of the channel sections may include a lens erector employing a reticle, but this is not required (it may be possible to utilize any lens assembly in the additional channel, in other embodiments). In embodiments including a lens erector employing a reticle, a consistent alignment enabled by monolithic housing may permit the use of reticle as an accurate aiming device for a laser rangefinder or some other accessory and/or modular package coupled to the folded optic.

In the illustrated embodiments, light is re-directed only twice inside the folded optic (e.g., each of the two channels includes a reflector). In other embodiments, it may be possible to use any number of internal reflections of light in a folded optic having a housing with integrally formed channel sections formed from pulled cores of a molding process (e.g., oppositely pulled cores).

In any embodiment described herein reflector assemblies may be employed in order to support new geometries resulting from the reduced distance between the center axes of the non-coaxial channels. In some examples, the housing may define reflector openings, such as threaded reflector openings 128 and 129 (FIG. 1C) to receive threaded reflector assemblies. FIG. 2D illustrates reflector assemblies 228 and 229 installed in threaded openings defined by the housing 200. In other examples, reflector openings may be arranged by some other attachment methods (e.g., bayonet attachment methods).

In various embodiments, any reflector assembly may be pivotable/tiltable (e.g., an adjustable reflector assembly), and may have their angle calibrated during manufacturing to optimize the light path. Once calibrated, the adjustable reflector assemblies may be locked into place at the calibrated angle (as a manufacturing step). Reflectors need not be adjustable in some embodiments, however. In some examples, it may be possible to use fixed reflector assemblies (e.g., not adjustable), which may install in threaded openings defined by a monolithic molded housing similar to any housing described herein.

### Examples

The illustrated embodiments describe some examples within the scope of the disclosure of the present application. However, other embodiments within the scope of this disclosure may include any one of the following examples.

Example 1 is a manufacture formed using a mold and plural cores, the manufacture comprising: a monolithic housing having ends and a length, the length defining a plurality of non-coaxial channels including: an objective channel for an objective lens assembly; and an additional channel for an additional lens assembly; the monolithic housing further including: a first core opening at an end of the ends, wherein the first core opening is configured to receive the objective lens assembly; and a second core opening at another end of the ends, wherein the second core opening is configured to receive the additional lens assembly.

Example 2 is the manufacture of example 1 or any other example herein, the monolithic housing further comprising a first reflector opening to locate a first reflector and a second reflector opening to locate a second reflector to re-direct reflected light from the first reflector through the additional lens assembly.

Example 3 is the manufacture of any of examples 1-2 or any other example herein, wherein the monolithic housing comprises a monolithic metal housing.

Example 4 is the manufacture of any of examples 1-3 or any other example herein, wherein the monolithic housing comprises a monolithic plastic or other non-metal housing.

Example 5 is the manufacture of any of examples 1-4 or any other example herein, wherein exterior bottom side of the length of the monolithic housing defines a mounting rail interface.

Example 6 is the manufacture of any of examples 1-5 or any other example herein, wherein the mounting rail interface comprise a dovetail rail.

Example 7 is the manufacture of any of examples 1-6 or any other example herein, wherein an exterior part of the length of the monolithic housing defines one or more openings having one or more adapters mounted thereto, respectively; wherein each adapter includes: an exterior to mate with a corresponding one of the one or more openings; and a threaded hole for mounting an optic accessory to the manufacture, the threaded hole to mate with a threaded length of a fastener of the optic accessory.

Example 8 is the manufacture of any of examples 1-7 or any other example herein, wherein at least one of the one or more adapters is ring-shaped, and wherein a center axis of the threaded hole is co-axial with a corresponding opening of the one or more openings.

Example 9 is the manufacture of any of examples 1-8 or any other example herein, wherein the monolithic housing is formed from a first material, and wherein the one or more adapters receive one or more threaded lengths of one or more fasteners, the one or more fasteners formed from a second material that is different than the first material.

Example 10 is the manufacture of any of examples 1-9 or any other example herein, wherein the second material has a hardness that is greater than the first material.

Example 11 is the manufacture of any of examples 1-10 or any other example herein, wherein a distance between center axes of the first and second openings is not greater than one half of a sum of a width of the first opening and a width of the second opening.

Example 12 is the manufacture of any of examples 1-11 or any other example herein, wherein a sidewall of at least one of the channels has a tapering thickness, in which the thickness increases moving away from a corresponding one of the core openings.

Example 13 a folded optic comprising the manufacture of any of examples 1-12 or any other example herein.

Example 14 is a folded optic, comprising: a housing having ends and a length, wherein the housing includes: an objective channel section defining an objective channel; and an additional channel section integrally formed with the objective channel section, the additional channel section defining an additional channel that is non-coaxial with the objective channel; an objective lens assembly mounted to the objective channel section; and an additional lens assembly mounted to the additional channel section.

Example 15 is the folded optic of example 14 or any other example herein, further comprising an asymmetrical baffle located in the additional channel section.

Example 16 is the folded optic of any of examples 14-15 or any other example herein, further comprising an asymmetrical baffle located in the objective channel section.

Example 17 is the folded optic of any of examples 14-16 or any other example herein, wherein an exterior of the additional channel section defines a mounting rail interface or other bi-directional mounting interface.

Example 18 is the folded optic of any of examples 14-17 or any other example herein, wherein an exterior of the one of the channel sections includes one or more openings having one or more adapters mounted thereto, respectively; wherein each adapter includes: an exterior to mate with a corresponding one of the one or more openings; and a threaded hole for mounting an optic accessory to the manufacture, the threaded hole to mate with a threaded length of a fastener of the optic accessory.

Example 19 is the folded optic of any of examples 14-18 or any other example herein, wherein the housing comprises a die-cast metal housing or an injection molded plastic housing.

Example 20 is the folded optic of any of examples 14-19 or any other example herein, wherein the assemblies are mounted to openings of the channels; wherein a distance from center axes of the openings is less than one half of a sum of widths of the openings.

It will be obvious to those having skill in the art that many changes may be made to the details of the above-described embodiments without departing from the underlying principles of the invention. The scope of the present invention should, therefore, be determined only by the following claims.

1. A manufacture formed using a mold and plural cores, the manufacture comprising:
a monolithic housing having ends and a length, the length defining a plurality of non-coaxial channels including:
an objective channel for an objective lens assembly; and
an additional channel for an additional lens assembly;
the monolithic housing further including:
a first core opening at an end of the ends, wherein the first core opening is configured to receive the objective lens assembly; and
a second core opening at another end of the ends, wherein the second core opening is configured to receive the additional lens assembly.

2. The manufacture of claim 1, the monolithic housing further comprising a first reflector opening to locate a first reflector and a second reflector opening to locate a second reflector to re-direct reflected light from the first reflector through the additional lens assembly.

3. The manufacture of claim 1, wherein the monolithic housing comprises a monolithic metal housing.

4. The manufacture of claim 1, wherein the monolithic housing comprises a monolithic plastic or other non-metal housing.

5. The manufacture of claim 1, wherein exterior bottom side of the length of the monolithic housing defines a mounting rail interface.

6. The manufacture of claim 5, wherein the mounting rail interface comprise a dovetail rail.

7. The manufacture of claim 1, wherein an exterior part of the length of the monolithic housing defines one or more openings having one or more adapters mounted thereto, respectively;
wherein each adapter includes:
an exterior to mate with a corresponding one of the one or more openings; and
a threaded hole for mounting an optic accessory to the manufacture, the threaded hole to mate with a threaded length of a fastener of the optic accessory.

8. The manufacture of claim 7, wherein at least one of the one or more adapters is ring-shaped, and wherein a center axis of the threaded hole is co-axial with a corresponding opening of the one or more openings.

9. The manufacture of claim 7, wherein the monolithic housing is formed from a first material, and wherein the one or more adapters receive one or more threaded lengths of one or more fasteners, the one or more fasteners formed from a second material that is different than the first material.

10. The manufacture of claim 9, wherein the second material has a hardness that is greater than the first material.

11. The manufacture of claim 1, wherein a distance between center axes of the first and second openings is not greater than one half of a sum of a width of the first opening and a width of the second opening.

12. The manufacture of claim 1, wherein a sidewall of at least one of the channels has a tapering thickness, in which the thickness increases moving away from a corresponding one of the core openings.

13. A folded optic comprising the manufacture of claim 1.

14. A folded optic, comprising:
a housing having ends and a length, wherein the housing includes:
an objective channel section defining an objective channel; and
an additional channel section integrally formed with the objective channel section, the additional channel section defining an additional channel that is non-coaxial with the objective channel;
an objective lens assembly mounted to the objective channel section; and
an additional lens assembly mounted to the additional channel section.

15. The folded optic of claim 14, further comprising an asymmetrical baffle located in the additional channel section.

16. The folded optic of claim 14, further comprising an asymmetrical baffle located in the objective channel section.

17. The folded optic of claim 14, wherein an exterior of the additional channel section defines a mounting rail interface or other bi-directional mounting interface.

18. The folded optic of claim 14, wherein an exterior of the one of the channel sections includes one or more openings having one or more adapters mounted thereto, respectively;
wherein each adapter includes:
an exterior to mate with a corresponding one of the one or more openings; and
a threaded hole for mounting an optic accessory to the manufacture, the threaded hole to mate with a threaded length of a fastener of the optic accessory.

19. The folded optic of claim 14, wherein the housing comprises a die-cast metal housing or an injection molded plastic housing.

20. The folded optic of claim 14, wherein the assemblies are mounted to openings of the channels;
wherein a distance from center axes of the openings is less than one half of a sum of widths of the openings.
